(19) United States
(12) Patent Application Publication
(10) Pub. No.: US 2018/0059658 A1
(43) Pub. Date: Mar. 1, 2018

(54) MANUFACTURING ABNORMALITY TRACKING AND REPAIR TOOL WITH GRAPHIC USER INTERFACE AND DATA PROCESSOR

(71) Applicant: Toyota Motor Engineering & Manufacturing North America, Inc., Erlanger, KY (US)

(72) Inventor: Christopher Rudolf Loates, Woodstock (CA)

(21) Appl. No.: 15/248,784

(22) Filed: Aug. 26, 2016

(51) Int. Cl. G05B 23/02; G05B 19/042

(52) U.S. Cl. CPC G05B 23/0289; G05B 2219/34465; G05B 19/0426

(57) ABSTRACT

An abnormality tracking and repair tool includes a tool performance database for storing information concerning tracking and repair of a manufacturing abnormality occurring in a product caused by at least one tool on an assembly line. The abnormality tracking and repair tool includes an abnormality management system in communication with the tool performance data base. The abnormality management system includes a programmable controller operable to scan the tool performance database for detecting occurrence of the manufacturing abnormality in the product. A graphic user interface in communication with the programmable controller includes a virtual assembly line with virtual workstations corresponding to each of the workstations of the assembly line. Each virtual workstation includes a manufacturing abnormality indicator identifying whether the workstation includes a product with a manufacturing abnormality.

### BACKGROUND

Assembly lines are used to mass assemble parts into a product such as a vehicle. Assembly lines are configured so as to sequentially and logically assemble the product from preassembled parts or raw material. The assembly line may include a plurality of workstations. Each workstation may perform a particular task that progressively assembles the finished product. Each workstation is equipped with specific tools to accomplish its assigned task. As each workstation completes its assigned task, the part is transferred downstream along the assembly line to the next workstation by a transfer system, such as a rail or a conveyor.

The workstation tools may be monitored and controlled by a programmable controller (PC). The PC controls and detects the functions and operations of each tool so as to determine whether or not that workstation has properly completed its assigned task.

Disruptions in assembly lines can lead to unwanted expense in lost time and labor. Disruptions may result from a process abnormality, meaning a tool malfunction, improper tool performance, or an assembly worker, also referenced herein as an operator, has not properly performed a task. In such an event, the PC may stop and prevent an improperly assembled part from advancing downstream. Thus the process abnormality or the improperly assembled part can cause a disruption in the manufacturing process which in turn causes economic loss to the manufacturer.

Current assembly line configurations may include a stop that prevents the assembly line from advancing a part downstream. The stop may be actuated manually or automatically. The assembly line may also include an override which bypasses the stop and allows the assembly line to continue to advance parts downstream. Further, current systems do not capture the identification of the person who actuated the override. Lastly, current systems do not feed information relating to tool malfunction downstream the assembly line to ensure that defective parts are repaired.

Accordingly, it is desirable to have a system which allows a part to advance along the manufacturing station in certain instances so as to minimize assembly line disruptions. However, it is also important and desirable to be able to identify the reasons why the part was not manufactured properly so that the error can be corrected later and also to identify the person who allowed the part to advance so as to be able to question the person and determine the reasons why. Further, it is also desirable to maintain a record of such occurrences so as to identify commonly recurring problems and provide corrective measures to prevent those problems from recurring.

### SUMMARY

Disclosed is a manufacturing abnormality tracking and repair tool employing a graphic user interface and data processor. The manufacturing abnormality tracking and repair tool may include an LCP system for controlling operation of an assembly line. The assembly line may include multiple workstations for sequentially assembling a product. The LCP system may receive instructions from an AVI system regarding specific tasks for assembling the product. The LCP system controls the operation of tools located at each of the workstations based on the information received from the AVI system.

The LCP system may send a set of operating instructions to tools located at the workstations. The LCP system may monitor operation of each tool to confirm that the operating instructions received from the AVI system have been properly performed. The LCP system flags operating instructions that have not been properly performed, and the associated tool, as possibly causing a manufacturing abnormality.

The manufacturing abnormality may be corrected at the workstation at which the abnormality originally occurred, or an operator may activate a bypass function to allow the product with the manufacturing abnormality to proceed down the assembly line to subsequent workstations. In instances where a bypass has occurred, the manufacturing abnormality will be investigated and corrected at one or more of the subsequent workstations. The occurrence of the bypass condition, along with information about the nature of the associated manufacturing abnormality, may be stored in a memory of the LCP system.

An abnormality management system automatically and continuously scans the memory in the LCP system searching for instances in which the bypass function has been activated. Upon detecting a bypass condition, the abnormality management system automatically retrieves information concerning the corresponding manufacturing abnormality and stores the information in memory of the abnormality management system.

To assist a user with coordinating correction of the detected manufacturing abnormality, the abnormality management system may generate a virtual assembly line that may be displayed on graphic user interface. The displayed information informs the user which product has the manufacturing abnormality and where on the assembly line the product is located. The graphic user interface also provides additional information about the nature of the manufacturing abnormality and possible corrective actions that may be taken to remedy the manufacturing abnormality. The user may use the displayed information to evaluate available options for correcting the manufacturing abnormality and determine an effective strategy for remedying the manufacturing abnormality.

### BRIEF DESCRIPTION OF THE DRAWINGS

The various features, advantages and other uses of the present apparatus will become more apparent by referring to the following detailed description and drawings, in which:

FIG. 1 is a schematic illustration of an assembly line employing an exemplary manufacturing abnormality tacking and repair tool and having a plurality of workstations equipped with tools for accomplishing a specific task;

FIG. 2 is a schematic illustration of the manufacturing abnormality tracking and repair tool including a graphic user interface;

FIG. 3 is a schematic illustration of a graphic user interface that may be employed with the manufacturing abnormality tracking and repair tool; and

FIG. 4 is a list of data types that may be analyzed by the manufacturing abnormality tracking and repair tool.

### DETAILED DESCRIPTION

A manufacturing abnormality tracking and repair tool with a graphic user interface and data processor is disclosed. The manufacturing abnormality tracking and repair system detects instances in which a tool in an assembly line has not properly performed a task for assembling a product, thereby causing a manufacturing abnormality in the product. To assist a user with coordinating correction of the manufacturing abnormality, an abnormality management system may generate a graphical virtual assembly line displayed on graphic user interface. The virtual assembly line informs the user which product has the manufacturing abnormality and where on the assembly line the product is located. The graphic user interface also provides additional information about the nature of the manufacturing abnormality and possible corrective actions that may be taken to remedy the manufacturing abnormality. The user may use the displayed information to evaluate available options for correcting the manufacturing abnormality and determine an effective strategy for remedying the manufacturing abnormality.

Referring now to the discussion that follows and also to the drawings, illustrative approaches to the disclosed systems and methods are described in detail. Although the drawings represent some possible approaches, the drawings are not necessarily to scale and certain features may be exaggerated, removed, or partially sectioned to better illustrate and explain the present invention. Further, the descriptions set forth herein are not intended to be exhaustive or otherwise limit or restrict the claims to the precise forms and configurations shown in the drawings and disclosed in the following detailed description.

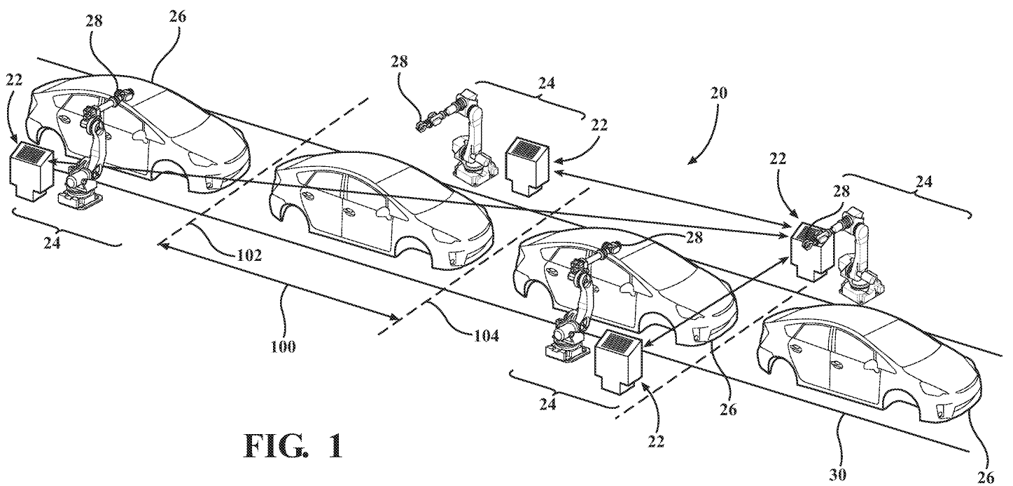

With reference to FIG. 1, an assembly line 20 may employ a manufacturing abnormality tracking and repair tool 22 for minimizing disruption in a manufacturing assembly process. The assembly line 20 may include individual workstations 24 arranged in a sequential manner so as to progressively assemble a product 26. The product 26 is illustrated as a vehicle, but may be any type or configuration. Each workstation 24 may be equipped with tools 28 for performing various predetermined tasks on the product 26. The product 26 may be automatically transferred along the assembly line 20 by a transfer system 30, such as a rail or a conveyor.

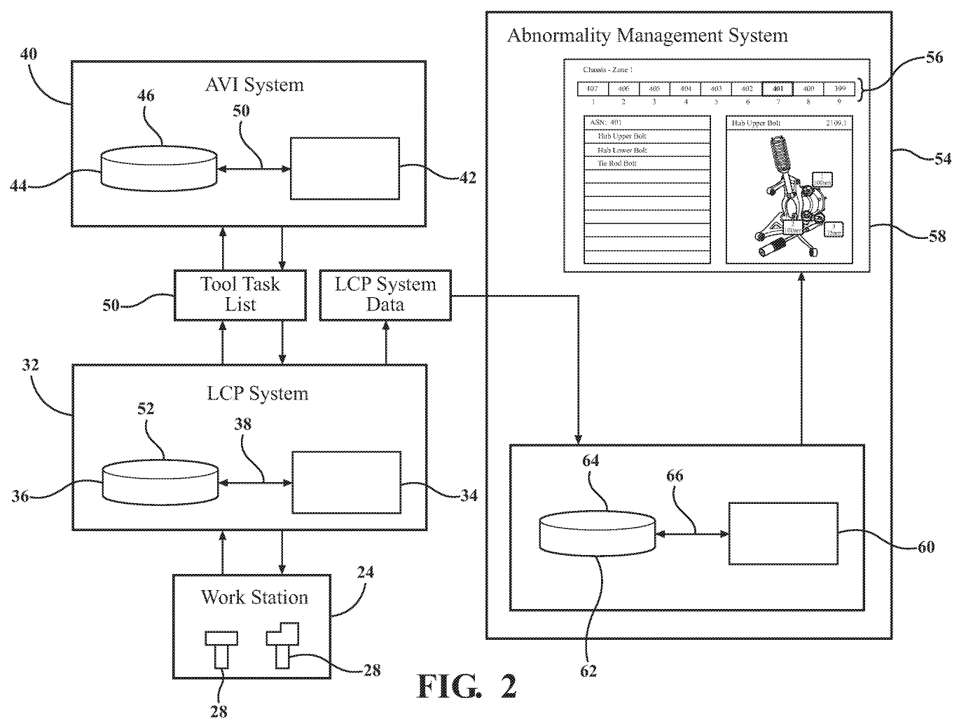

With reference to FIG. 2, the manufacturing abnormality tracking and repair tool 22 may include a line control process system 32 (LCP system) for controlling operation of the assembly line 20 and each of the tools 28 in the workstations 24. The LCP system 32 may be any type of handheld, desktop, or other form of single computing device, or may be composed of multiple computing devices. The LCP system 32 may include an LCP processing unit 34, which may be configured as a conventional central processing unit (CPU) or any other type of device, or multiple devices, capable of manipulating or processing information. An LCP memory 36 in the LCP system 32 may be a random access memory device (RAM) or any other suitable type of storage device. LCP memory 36 may include data that may be accessed by the LCP processing unit 34 using a bus 38.

The LCP memory 36 may also include an operating system and installed applications and/or software, including programs that permit the LCP processing unit 34 to control operation of the assembly line 20 and tools 28. The LCP system 32 may also include secondary, additional, or external storage, for example, a memory card, flash drive, or any other form of computer readable medium. The installed applications and/or software may be stored in whole or in part in external storage and loaded into the LCP memory 36 as needed for processing.

The LCP system 32 may receive assembly instructions for assembling the product 26 present on the assembly line 20 from an assembly vehicle information system 40 (AVI system). The AVI system 40 may be any type of handheld, desktop, or other form of single computing device, or may be composed of multiple computing devices. The AVI system 40 may include an AVI processing unit 42, which may be configured as a conventional central processing unit (CPU) or any other type of device, or multiple devices, capable of manipulating or processing information.

An AVI memory 44 in the AVI system 40 may be a random access memory device (RAM) or any other suitable type of storage device. The AVI memory 44 may include an AVI database 46 that may be accessed by the AVI processing unit 42 using a bus 50. The AVI database 46 stores information relating to tool 28 performance and tasks. The AVI system 40 may provide the LCP system 32 with a list of tasks that each tool 28 is to perform on the product 26. A tool task list 50 describing tasks to be performed on the product 26 is provided for each workstation 24 (as shown, for example, in FIG. 1). The tool task list 50 may include a description and sequence of tasks to be performed at each workstation 24. The tasks performed at each workstation 24 may vary depending on the configuration of the product 26 being assembled.

The AVI memory 44 may also include an operating system and installed applications and/or software, including programs that permit the AVI processing unit 42 to access product assembly instructions and data and transmit the information to the LCP system 32. The AVI system 40 may also include secondary, additional, or external storage, for example, a memory card, flash drive, or any other form of computer readable medium. The installed applications and/or software may be stored in whole or in part in external storage and loaded into the AVI memory 44 as needed for processing.

The LCP system 32 may include tool sensors that monitor the operational status and progress of the tools 28. The tool sensors generate sensor data may be used by the LCP system 32 to determine if the tools 28 are properly executing their assigned tasks and whether the product 26 is being correctly assembled.

The LCP system 32 may receive the tool task list 50 from the AVI system 40. The tool sensors transmit tool performance data to the LCP system 32 regarding the tools 28 performance. The LCP system 32 may compare the tool sensor data to the information in the tool task list 50 received from the AVI system 40 to ensure that the tasks on the tool task list 50 have been completed in the prescribed manner. The LCP system 32 tracks the tool performance data for each task performed by the tools 28. The tool performance data may be stored in an LCP tool performance database 52 in LCP memory 36.

The LCP system 32 continuously monitors performance of the tools 28 to ensure they are operating properly. If the LCP system 32 determines that a tool 28 is not performing in accordance with the tool task list 50, the LCP system may flag the product 26 on which the tool 28 did not properly perform the assigned task as possibly including a manufacturing abnormality. Information concerning the manufacturing abnormality may be stored in the LCP tool performance database 52. The LCP system 32 may also cause the assembly line 20 to stop and the tools 28 to cease performing their assigned task to prevent the product 26 with the manufacturing abnormality from proceeding along the assembly line 20 to subsequent workstations 24.

Stoppage of the assembly line 20 by the LCP system 32 as a result of a manufacturing abnormality being detected in the product 26 may be overridden by a user. The LCP system 32 may include an override function that can be actuated by the user to instruct the LCP system 32 to advance the product 26 downstream the assembly line 20, even though a prescribed task has not been satisfactorily performed on the product 26. The override function helps minimize disruptions in the manufacturing process by allowing the product 26 to proceed along the assembly line 20 to subsequent workstations 24 with the intent that the manufacturing abnormality will be corrected further down the assembly line.

The override function may be activated in a variety of ways. For example, the LCP system 32 may include a magnetic card reader operable to read the identity of the card holder and allow the card holder to activate the override function. Alternatively, the LCP system 32 may employ a button operable to obtain the fingerprint of a person and activate the override function. The LCP system 32 may alternately employ various other mechanisms for activating the override function.

The LCP system 32 may be in communication with an abnormality management system 54 (AMS). The AMS 54 may be configured to automatically and continuously scan the LCP tool performance database 52 to detect the occurrence of manufacturing abnormalities in which a task has not been properly performed on the product 26. If a manufacturing abnormality is detected, the AMS 54 may generate a virtual assembly line 56 of the assembly line 20 and the products 26 proceeding along the assembly line. The virtual assembly line 56 may be displayed in a graphic user interface 58. The virtual assembly line 56 may include information concerning the location of each product 26 on the assembly line 20, the nature of the manufacturing abnormality and the status of any corrective action taken to remedy the manufacturing abnormality. The information may assist a user in effectively coordinating repairs to correct the manufacturing abnormality.

The AMS 54 may be any type of handheld, desktop, or other form of single computing device, or may be composed of multiple computing devices. The AMS 54 may include an AMS processing unit 60, which may be configured as a conventional central processing unit (CPU) or any other type of device, or multiple devices, capable of manipulating or processing information.

An AMS memory 62 in the AMS 54 may be a random access memory device (RAM) or any other suitable type of storage device. The AMS memory 62 may include an AMS database 64 that may be accessed by the AMS processing unit 60 using a bus 66. The AMS database 64 may store information retrieved from the LCP system 32 concerning tasks performed by the tools 28 and whether the tasks have been properly performed.

The AMS memory 62 may include an operating system and installed applications and/or software, including programs that permit the AMS processing unit 60 to continuously scan the LCP tool performance database 52 and retrieve tool performance information that may be used to generate the virtual assembly line 56. The AMS 54 may also include secondary, additional, or external storage, for example, a memory card, flash drive, or any other form of computer readable medium. The installed applications and/or software may be stored in whole or in part in external storage and loaded into the AMS memory 62 as needed for processing.

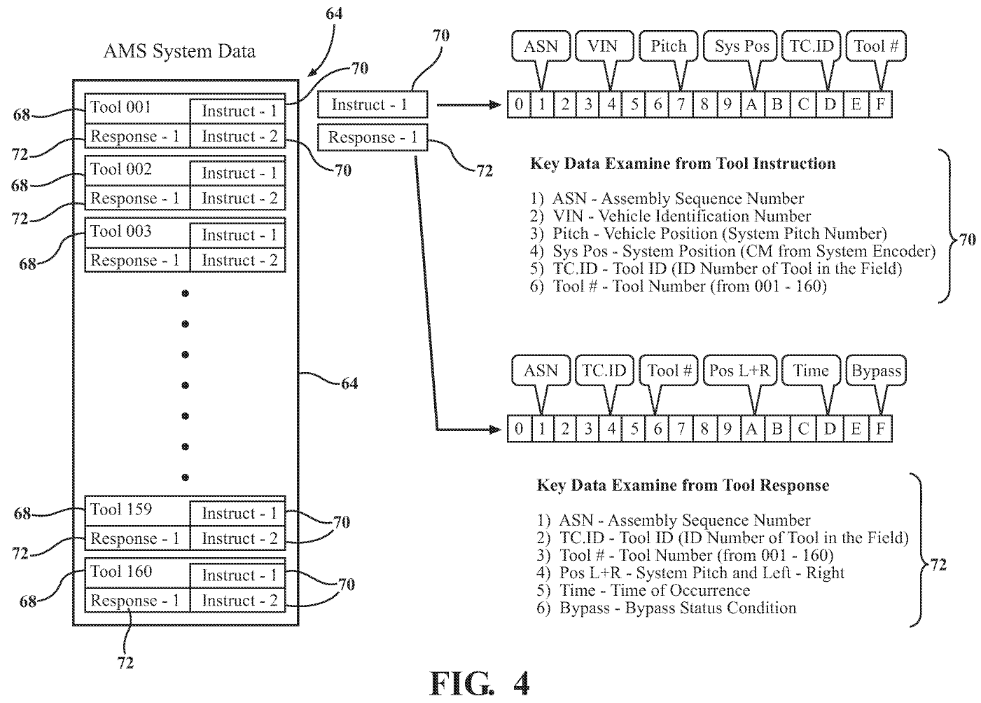

FIG. 4 provides an example of the type of data and information that the AMS 54 may retrieve from the LCP tool performance database 52 and store in the AMS database 64. The data/information may include a unique tool identifier 68 assigned to each tool 28. The data may also include one or more tool operating instructions 70 received from the AVI system 40. Also included in the data may be a tool operating response 72 that may be based, at least in part, on the sensor data received by the LCP system. FIG. 4 also lists some of the information that may be included in the tool operating instructions 70, as well as information that may be include in the tool operating response 72 generated by LCP system 32.

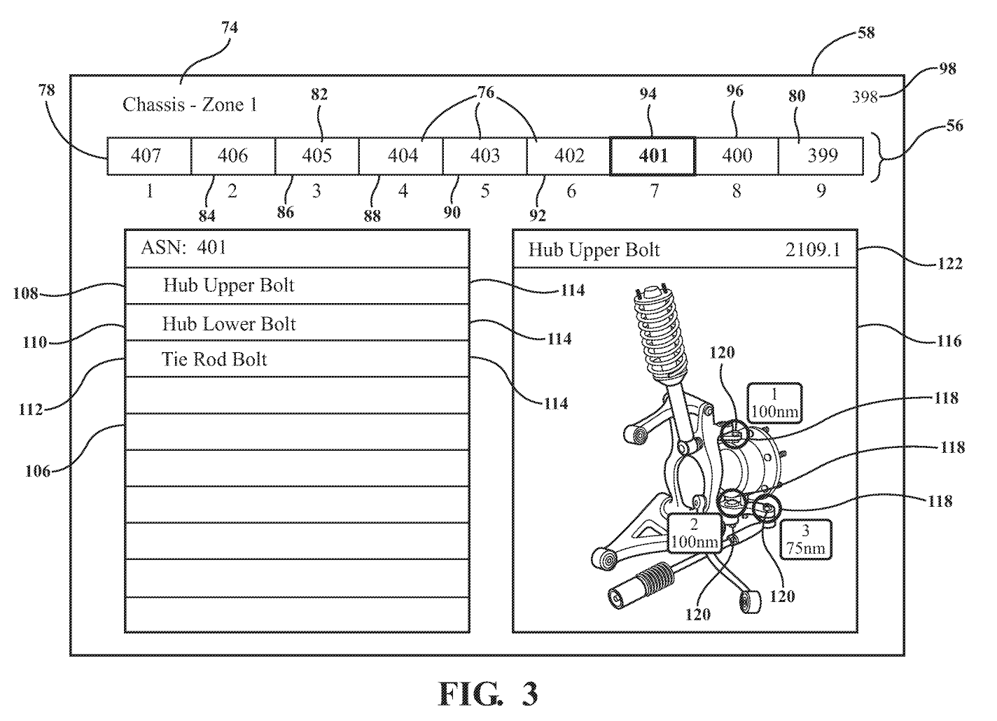

With reference to FIGS. 2 and 3, the AMS 54 may include the graphic user interface 58 for displaying the virtual assembly line 56 generated by the AMS 54. The graphic user interface 58 visually transmits real-time tool performance information retrieved from the LCP system 32 for each product 26 on the assembly line 20. The displayed information informs a user whether the product 26 is being properly assembled and if any potential manufacturing abnormalities have been detected. A user can determine from the displayed information the actual location on the assembly line 20 of the product 26 with the manufacturing abnormality and the nature of the abnormality. The displayed information may include the location of the product 26 with the manufacturing abnormality relative to other products 26 on the assembly line 20. Potential corrective actions for remedying the manufacturing abnormality may also be displayed on the graphic user interface 58. The displayed information may assist a user with coordinating inspection and repair of the manufacturing abnormality. The displayed information may also provide the user with affirmative feedback that the manufacturing abnormality has been corrected.

With reference to FIG. 3, the graphic user interface 58 may display various information and data concerning the product 26 being assembled on the assembly line 20. The graphic user interface 58 may indicate a monitored assembly line 74 assigned to the particular assembly line 20 being monitored and controlled by the LCP system 32. It is not necessary that any particular naming convention be used, and the assigned name for the assembly line 20 may include any combination of letters, numbers and characters.

The graphic user interface 58 may include the virtual assembly line 56 that graphically depicts the assembly line 20 corresponding to the monitored assembly line 74 identified on the graphic user interface 58. The virtual assembly line 56 may include a series of virtual workstations 76 corresponding to each of the workstations 24 of the monitored assembly line 74. Each virtual workstation 76 may be individually depicted on the graphic user interface 58 as a geometric shape, for example, a rectangle. Alternatively, other geometric shapes may be used to represent the virtual workstations 76. Each individual virtual workstation 76 corresponds to a separate workstation 24 of the monitored assembly line 74. The number of virtual workstations 76 shown on graphic user interface 58 may correspond with the number of workstations 24 in the monitored assembly line 74.

The virtual workstations 76 may each be assigned a unique identifying character(s). In this particular example the monitored assembly line 74 includes a total of nine workstations. Each virtual workstation 76 may accordingly be assigned a unique number from 1 to 9. Other characters may alternatively be used to uniquely identify each of the virtual workstations 76 on the graphic user interface 58. A first virtual workstation 78 (identified as workstation no. 1 on graphic user interface 58) located at the far left of the virtual assembly line 56 (as viewed from the perspective of FIG. 3), corresponds to the start the monitored assembly line 74, and the ninth virtual workstation 80 (identified as workstation no. 9 on graphic user interface 58) located at the far right of the virtual assembly line 56 coincides with the end of the monitored assembly line 74. The product 26 moves consecutively through each of the virtual workstations 76 (corresponding to the workstations 24 in the monitored assembly line 74) starting with the first virtual workstation 78 and ending with the ninth virtual workstation 80.

Products 26 moving along the monitored assembly line 74 may each be assigned a unique assembly sequence code 82. In this example the assembly sequence code 82 includes a series of numbers, but may also include other characters and/or symbols. The assembly sequence codes appear on the virtual assembly line 56 in descending order from left to right (as viewed from the perspective of FIG. 3), due to the fact that the product 26 assigned assembly sequence code “399” entered the monitored assembly line 74 prior to the product 26 assigned assembly sequence code “407”. The virtual assembly line 56 may continuously update as the products 26 move along the monitored assembly line 74, thus showing in real-time the location of each product 26 on the monitored assembly line 74 at any given time.

The virtual workstations 76 may be highlighted with various colors used to identify the manufacturing status of the product 26 present at the particular workstation 24. For example, a red colored virtual workstation 76 may indicate that the product 26 situated at the particular workstation 24 on assembly line 20 may include a manufacturing abnormality. On the other hand, a green colored virtual workstation 76 may indicate that the product 26 present at the particular workstation 24 has, up to that point, been properly assembled and no manufacturing abnormalities have been detected.

For example, in the virtual assembly line 56 illustrated in FIG. 3, virtual workstations 78, 84-92, 96 and 80 may be green colored to indicate that no manufacturing abnormalities have been previously detected in the products 26 assigned assembly sequence codes “400”, “399” and “402” through “407”. The virtual workstation 94, at which the product 26 assigned assembly sequence code “401” is located, may be highlighted red to indicate that a manufacturing abnormality has been detected in the product 26. The color coding enables a user to quickly and easily determine the manufacturing status of each product 26 proceeding along the monitored assembly line 74, and whether a manufacturing abnormality has been detected in a particular product.

The graphic user interface 58 may also include a product location indicator 98 that identifies where within a particular workstation 24 the product 26 is located. The product location indicator 98 may, for example, correspond to a distance 100 (see for example, FIG. 1) extending from a beginning 102 of the particular workstation 24 to a position 104 at which the product 26 is located within the workstation 24. The product location indicator 98 may continuously update as the product 26 moves through the workstation 24.

The graphic user interface 58 may include a workstation tool list 106 identifying each tool 28 used to perform a task on a product 26 at the particular workstation 24. The workstation tool list 106 identifies each of the tools 28 used at a particular workstation 24. For example, in FIG. 3, the workstation tool list 106 shown on graphic user interface 58 identifies the tools 28 used to perform tasks on the product 26 denoted by assembly sequence code “401” located at virtual workstation 94 (i.e., workstation number “7” on graphic user interface 58). In this particular example, three tools 108, 110 and 112 perform tasks on the product 26 assigned assembly sequence code “401”. Each tool 108, 110 and 112 may include a tool name assigned to the particular tool. The tool name may include any combination of alphanumeric characters and/or symbols. In the illustrated example, each tool name is assigned a name and a number. Other naming conventions may also be employed.

Each tool 108, 110 and 112 identified in the workstation tool list 106 may be highlighted by a tool status indicator 114 that indicates whether the particular tool may have caused a manufacturing abnormality to occur. The tool status indicator 114 may use alternate colors to distinguish between tools operating properly and those which may have caused a manufacturing abnormality to occur. For example, a red colored tool may indicate that the particular tool has caused a manufacturing abnormality to occur in the product 26. On the other hand, a green colored tool may indicate that the tool is operating properly and has not caused any manufacturing abnormalities. For example, in the workstation tool list 106 shown on graphic user interface 58 in FIG. 3, tools 110 and 112 may include a green colored tool status indicator to indicate they are functioning properly and have not caused any manufacturing abnormalities. Tool 108, on the other hand, may include a red colored tool status indicator to indicate that the tool may have caused a manufacturing abnormality to occur in the product 26 identified by assembly sequence code “401”. The color coding enables a user to quickly and easily determine which tool may have caused a manufacturing abnormality.

The graphic user interface 58 may include a product assembly image 116 showing the location of a potential manufacturing abnormality. The product assembly image 116 may include a photograph or graphical depiction of the area of interest on the product 26. The region of the product 26 in which the manufacturing abnormality may have occurred may be identified by an abnormality position locator 118. The abnormality position locator 118 may be configured as a geometric shape surrounding the particular component or feature of the product 26, for example a bolt 120, that may have been improperly assembled and was flagged by the LCP system 32 as possibly having a manufacturing abnormality. In the illustrated example shown in FIG. 3, the abnormality position locator 118 is depicted as a circle surrounding the component (i.e., bolt 120) in which the manufacturing abnormality occurred. In practice, other geometric shapes may also be used.

The color of the abnormality position locator 118 may be varied to indicate whether the manufacturing abnormality has been corrected or still needs correcting. For example, the abnormality position locator 118 may be colored red to indicate that the identified manufacturing abnormality has not yet been remedied. The abnormality position locator 118 may change from red to green to indicate that the manufacturing abnormality has been corrected. In practice, other colors or visual indicators may be used to signal whether a manufacturing abnormality has been corrected or still needs to be addressed.

The particular tool 28 that caused the manufacturing abnormality may be indicated on the product assembly image 116, for example, in an image header 122. In this particular example, the tool 28 entitled “Hub Upper Bolt 2109.1” is listed in the image header 122 as the source of the manufacturing abnormality. The corresponding tool 28 that may have caused bolt 120 to be improperly torqued is identified in the image header 122 and the bolt 120 is identified on the product assembly image 116 by a red abnormality position locator 118. The abnormality position locator 118 may change to green once the proper torque for bolt 120 has been confirmed and the manufacturing abnormality has been corrected.

The AVI system 40, LCP system 32 and the AMS 54 may be configured as separate and distinct computing devices, for example, as described above. Alternatively, one or more of the AVI system 40, LCP system 32 and AMS 54 may be integrated together in a common computing device that may be similarly configured as one of more of the computing devices described above.

The following description provides an example of how the manufacturing abnormality tracking and repair tool 22 may be used to assist with effectively and accurately correcting manufacturing abnormalities. With reference to FIGS. 1-4, the LCP system 32 receives instructions from the AVI system 40 describing the assembly task to be performed by each tool 28 at each of the workstations 24 in the assembly line 20. The tasks performed at each workstation 24 may vary depending on the configuration of the product 26 being assembled. The LCP system 32 controls the operation of the tools 28 located at each of the workstations 24 based on the information received from the AVI system 40.

The LCP system 32 sends a set of operating instructions to each tool 28 located at the workstations 24. The LCP system 32 monitors the operation of each tool 28 to confirm that the operating instructions have been properly performed. The LCP system 32 flags operating instructions that have not been properly performed and the associated tool 28 as possibly causing a manufacturing abnormality.

The manufacturing abnormality may be corrected at the workstation at which the abnormality originally occurred, or an operator may activate the bypass function to allow the product 26 with the manufacturing abnormality to proceed down the assembly line 20 to subsequent workstations 24. In instances where a bypass has occurred, the manufacturing abnormality will be investigated and corrected at one or more of the subsequent workstations 24. The occurrence of the bypass condition, along with information about the nature of the associated manufacturing abnormality, may be stored in the LCP memory 36 of the LCP system 32.

The AMS 54 automatically and continuously scans the LCP memory 36 of the LCP system 32 searching for instances in which the bypass function has been activated. Upon detecting a bypass condition, the AMS 54 automatically retrieves information concerning the corresponding manufacturing abnormality and stores the information in the AMS memory 62 of the AMS 54.

To assist a user with coordinating correction of the detected manufacturing abnormality, the AMS 54 generates a virtual assembly line 56 on the graphic user interface 58 to inform the user which product 26 has the manufacturing abnormality and where on the assembly line the product 26 is located. The graphic user interface 58 also provides additional information about the nature of the manufacturing abnormality and possible corrective actions that may be taken to remedy the manufacturing abnormality. The user may use the displayed information to evaluate available options for correcting the manufacturing abnormality and determine an effective strategy for remedying the manufacturing abnormality.

For example, by knowing the precise location along the assembly line 20 of the product 26 having the manufacturing abnormality, as well as information concerning the nature of the abnormality, the user can assess which of the downstream workstations 24 may be best suited for repairing the manufacturing abnormality. Also, with knowledge about the nature of the manufacturing abnormality the user can assess how much time may be required to correct the abnormality and determine which of the downstream workstations 24 may be best suited for completing the repairs within the time period the product 26 is present at the workstation.

These above are a few examples of the ways in which the information displayed on graphic user interface 58 may be used to effectively coordinate repair of a manufacturing abnormality. Upon completion of the repairs the graphic user interface 58 is updated to inform the user that the manufacturing abnormality has been corrected. This simplifies tracking of the repairs and frees the user to concentrate on ensuring that repairs yet to be completed are addressed in as efficient and timely manner as possible.

It is intended that the scope of the present methods and apparatuses be defined by the following claims. However, it must be understood that the disclosed systems and methods may be practiced otherwise than is specifically explained and illustrated without departing from its spirit or scope. It should be understood by those skilled in the art that various alternatives to the configurations described herein may be employed in practicing the claims without departing from the spirit and scope as defined in the following claims. The scope of the disclosed systems and methods should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future examples. Furthermore, all terms used in the claims are intended to be given their broadest reasonable constructions and their ordinary meanings as understood by those skilled in the art unless an explicit indication to the contrary is made herein. In particular, use of the singular articles such as “a,” “the,” “said,” etc., should be read to recite one or more of the indicated elements unless a claim recites an explicit limitation to the contrary. It is intended that the following claims define the scope of the device and that the method and apparatus within the scope of these claims and their equivalents be covered thereby. In sum, it should be understood that the device is capable of modification and variation and is limited only by the following claims.

What is claimed is:

1. An abnormality tracking and repair tool for coordinating correction of a manufacturing abnormality occurring in a product assemble on an assembly line, the assembly line including at least one workstation sequentially arranged so as to progressively assemble the product, each workstation equipped with at least one tool for performing a predetermined task on the product, the abnormality tracking and repair tool comprising:
a tool performance database for storing information concerning an occurrence and repair of a manufacturing abnormality in the product caused by the at least one tool; and
an abnormality management system in communication with the tool performance database, the abnormality management system including:
a programmable controller operable to scan the tool performance database for detecting occurrence of the manufacturing abnormality in the product; and
a graphic user interface in communication with the programmable controller, the graphic user interface including a virtual assembly line including at least one virtual workstation corresponding to each of the one or more workstations of the assembly line, whereas each virtual workstation includes a manufacturing abnormality indicator identifying whether the at least one workstation includes a product with a manufacturing abnormality.

2. The abnormality tracking and repair tool of claim 1, wherein the graphic user interface further comprises a workstation tool list identifying each of the at least one tool operable within the at least one workstation.

3. The abnormality tracking and repair tool of claim 2, wherein each tool in the workstation tool list comprises a tool status indicator identifying whether the tool caused the manufacturing abnormality.

4. The abnormality tracking and repair tool of claim 3, wherein the graphic user interface further comprises a first tool status indicator identifying each tool in the workstation tool list that is operating properly and a second tool status indicator identifying each tool in the workstation tool list that caused a manufacturing abnormality to occur.

5. The abnormality tracking and repair tool of claim 4, wherein the first tool status indicator comprises a first color and the second tool status indicator comprises a second color different from the first color.

6. The abnormality tracking and repair tool of claim 1, wherein the graphic user interface further comprises a product assembly image identifying a location of the manufacturing abnormality on the product.

7. The abnormality tracking and repair tool of claim 6, wherein the product assembly image comprises an abnormality position locator identifying a location on the product where the manufacturing abnormality occurred.

8. The abnormality tracking and repair tool of claim 7, wherein the abnormality position locator may be alternately displayed as a first abnormality position locator indicating the manufacturing abnormality has been corrected and a second abnormality position locator indicating that the manufacturing abnormality has not been corrected.

9. The abnormality tracking and repair tool of claim 8, wherein the first abnormality position locator comprises a first color and the second abnormality position locator comprises a second color different from the first color.

10. The abnormality tracking and repair tool of claim 1, wherein the manufacturing abnormality indicator comprises a first manufacturing abnormality indicator identifying each workstation of the at least one workstation that does not include a product with a manufacturing abnormality and a second manufacturing abnormality indicator identifying each workstation of the at least one workstation that include a product with a manufacturing abnormality.

11. The abnormality tracking and repair tool of claim 10, wherein the first manufacturing abnormality indicator comprises a first color and the second manufacturing abnormality indicator includes a second color different from the first color.

12. The abnormality tracking and repair tool of claim 10, wherein the programmable controller is operable to cause the graphic user interface to change the first manufacturing abnormality indicator to the second manufacturing abnormality indicator in response to the programmable controller detecting repair of the manufacturing abnormality.

13. The abnormality tracking and repair tool of claim 1, wherein the programmable controller is operable to cause the graphic user interface to update the virtual assembly line in response to movement of the product along the assembly line.

14. The abnormality tracking and repair tool of claim 1, wherein each of the at least one virtual workstation comprises an assembly sequence code identifying a particular product present at the workstation.

15. An abnormality tracking and repair tool for coordinating correction of a manufacturing abnormality occurring in a product assemble on an assembly line, the assembly line including at least one workstation sequentially arranged so as to progressively assemble the product, each workstation equipped with at least one tool for performing a predetermined task on the product, the abnormality tracking and repair tool comprising:
a graphic user interface; and
a programmable controller for controlling operation of the graphic user interface, the controller operable to cause a virtual assembly line having at least one virtual workstation to be displayed on the graphic user interface, whereas the controller causes each of the at least one virtual workstation to display one of a first manufacturing abnormality indicator identifying the workstation as including a product without a manufacturing abnormality and a second abnormality indicator identifying the workstation as including a product with a manufacturing abnormality.

16. The abnormality tracking and repair tool of claim 15, wherein the graphic user interface further comprises:
a workstation tool list including a tool status indicator identifying which tools listed in the workstation tool list caused a manufacturing abnormality in the product; and
a product assembly image including an abnormality position locator identifying a location on the product where the manufacturing abnormality occurred.

17. The abnormality tracking and repair tool of claim 16, wherein the programmable controller is operable to selectively modify a configuration of at least one of the tool status indicator and the abnormality position locator in response to information retrieved from a tool performance database.

18. The abnormality tracking and repair tool of claim 17, wherein the tool performance database includes information concerning occurrence and repair of a manufacturing abnormality in the product caused by the at least one tool.
